(19) United States
(12) Patent Application Publication
(10) Pub. No.: US 2009/0301652 A1
(43) Pub. Date: Dec. 10, 2009

(54) USE OF ANTI-SLIP FILM IN PALLETS

(75) Inventor: Klaus Grahlher, Buchholz (DE)

Correspondence Address: Casimir Jones, S.C., 2275 DEMING WAY, SUITE 310, MIDDLETON, WI, 53562, US

(73) Assignee: SANSTRAP VERPACKUNGEN GMBH, Glinde (DE)

(21) Appl. No.: 12/479,049

(22) Filed: Jun. 5, 2009

(30) Foreign Application Priority Data
Jun. 6, 2008 (EP) 08010378.1

(51) Int. Cl. B32B 38/00; B32B 37/00

(52) U.S. Cl. 156/256; 156/60

(57) ABSTRACT

The invention relates to the use of a film for securing goods (3) arranged in layers on a pallet (5) against sliding, the film being introduced between an upper layer (2′) and a lower layer (2) and having antislip properties. There is provision according to the invention for the film to be cut to size in film strips (1) the length of which is greater than their width, and for the film strips (1) to be arranged between the lower layer (2) and the upper layer (2′) in such a way that they cover a maximum of 60% of the contact area of the lower layer (2) with the upper layer (2′).

The invention relates to the use of a film for securing goods arranged in layers on a pallet against sliding.

Stackable goods are often combined on pallets for transport purposes. Here, the goods are stacked on a pallet in layers, it being possible for a layer to comprise only one goods item or a plurality of goods which are arranged next to one another.

In order to secure the individual layers against sliding during the transport of the pallet, it is known to provide antislip paper between the individual layers, by which antislip paper the friction between two layers is increased. The paper can be obtained in the form of individual sheets. Here, the dimensions of the individual sheets correspond to the dimensions of the pallet, and are thus, for example, 1200 mm×800 mm in the case of a Europool pallet, which ensures that a layer can always be covered completely with the antislip paper. However, the paper overhangs in layers the upper side of which does not correspond to the dimensions of the underlying pallet. Moreover, depending on the size of the pallet, the storage, the transport and the use of correspondingly large sheets can prove impractical and unwieldy.

The invention is based on the object of providing a possibility for securing goods arranged in layers on a pallet against sliding, which possibility does not have the disadvantages known in the prior art, or only has them to a lesser extent.

A solution of this problem is the subject matter of the main claim. A further solution of this problem is the subject matter of the further independent claim.

Advantageous developments result from the respective subclaims.

If a film is used according to the invention for securing goods arranged in layers on a pallet against sliding, the film which has antislip properties is introduced between an upper layer and a lower layer, the film being cut to size in strips and being arranged on the lower layer in such a way that it covers at most 60% of the contact area between the upper and lower layers. The term “contact area” denotes that surface area, over which the upper and lower layers are in contact with one another in a load-transmitting manner. According to the invention, the film is preferably arranged in the edge region of said contact area, with the result that boxes which are arranged at the edge of a layer, for example, are secured against sliding or tilting and in this way central boxes of the same layer which are enclosed by said edge boxes are secured against sliding, even if they themselves in some circumstances lie completely or partially directly on the layer arranged underneath, and not with an antislip film inserted in between.

In a further use according to the invention of a film for securing goods arranged in layers on a pallet against sliding, there is provision for one or more goods to be banded with a film to form a goods stack, the film for the band being an antislip film.

The antislip film is flexible and is preferably manufactured from plastic or composite materials. Suitable plastics are, for example, polyethylene, polypropylene, PVC or the like. The thickness preferably lies between 2 μm and 1 mm, preferably from 10 μm or 20 μm to 1 mm. Preferred thicknesses are from 30 to 80 μm. The film can comprise a plurality of layers. For example, a film core which imparts the necessary strength can be provided or coextruded with coatings which impart antislip properties. A film has antislip properties when it sets or increases the coefficient of static friction and/or sliding friction to a magnitude which is sufficient for the provided purpose. It is particularly preferred if the film is constructed from three layers, the center layer being configured as a tearproof carrier film and the outer layers ensure the antislip and/or adhesive action.

The expression “lower layer” also includes the pallet itself, with the result that the use according to the invention of film between the pallet (according to the invention, this expression includes a device of any kind, on which goods can be stacked for storage and/or transport) and that layer of goods which lies directly on the pallet is covered by the invention.

The expression “edge or outer boxes or goods” denotes the goods of a layer which are not adjoined in at least one direction by any goods item which is loaded by the layer lying above it. It is possible here that the “outer goods item” is situated at the edge of the layer and no further goods item is situated in at least one horizontal direction; however, it is also possible that a goods item which is not situated at the edge is an “outer goods item”, in so far as a goods item of the layer lying on top rests on said “outer goods item” and a goods item which is not loaded by the layer which lies above it is situated next to said goods item. The latter can be the case, for example, when an upper layer does not have the same horizontal dimensions as the lower layer.

“Goods stack” denotes a combination of goods, in which the individual goods are connected fixedly to one another by banding, for example. However, the expression “goods stack” also includes the case, in which only a single goods item is banded.

On account of the fact that the film is cut to size in strips, the application of the film, that is to say the positioning onto a lower layer before the upper layer is placed onto it, is simplified, since the strips are more manageable than a continuous sheet having the dimensions of the pallet. Moreover, material can be saved, since the lower layer does not have to be covered completely with an antislip paper. In addition to cost savings, this benefits the environment. The reuse of the film is facilitated, since the risk of a film strip tearing is lower than a continuous paper sheet having the size of the pallet tearing.

Sufficient protection against sliding is ensured despite material being saved. This is true, in particular, for short distance transport of stacked pallet goods within a store.

Since the outer goods of two layers which are arranged above one another preferably lie on one another via the film, sufficient protection against tipping is ensured. Individual outer goods which are stacked above one another (what are known as columns) are preferably connected to the adjacent columns via the films which are clamped in between two layers. This means that preferably one film strip extends over two or more columns of this type in the plane between two layers and connects said columns effectively to form a unit which is secured in an improved manner against tipping.

It is particularly preferred if from 20% to 50%, preferably from 28% to 42%, of the contact area between two layers is covered by the film. Coverage in this ratio has proven sufficient to ensure the protection against sliding.

The film strips preferably have a width of from 50 to 350 mm, more preferably of from 100 to 250 mm, and more preferably of approximately 150 mm. The desired coverage ratios can be achieved by the application of a corresponding number of film strips to the lower layer, without it being necessary for the film to be provided in unmanageable dimensions.

The film strips preferably have a ratio of length to width of from 1.5:1 to 12:1, preferably of from 2:1 to 10:1, more preferably of from 3:1 to 8:1, and more preferably of from 4:1 to 6:1.

The film can be wound up onto a winding apparatus, the reel width corresponding to the width of the film strips. Moreover, a dividing element which makes it possible to divide a film strip of any desired length can be provided on the winding apparatus. It is also possible by way of an apparatus of this type to obtain film strips with the lengths which are required for the use according to the invention, independently of the dimensions and/or the shape of the lower layer.

There can also be provision for the film to be perforated at regular intervals. Here, the perforation preferably extends in the direction of the width. If a correspondingly perforated film is wound onto a reel, the width of which corresponds to the width of the film strips, the perforation then extends parallel to the axis of the reel. Thanks to the perforation, it is possible to obtain film strips having a length which corresponds to a multiple of the regular spacing between two perforations. It is particularly preferred here if the spacing between two perforations is from 100 to 500 mm, preferably from 200 to 400 mm, more preferably 300 mm.

The film strips preferably have a length of at most 1200 mm. Simple manageability is ensured up to this length. It is particularly preferred if the film strips have a length of from 300 to 900 mm.

The film preferably has a thickness of from 10 to 100 μm, preferably of from 40 to 60 μm, more preferably of 50 μm. The weight per unit area of the film is preferably from 20 to 100 g/m², more preferably from 30 to 80 g/m², and more preferably from 40 to 60 g/m².

The protection against sliding is determined definitively from the coefficient of friction between the film and the goods. The coefficients of friction between film and corrugated cardboard and film and board can be determined according to the method which is defined in DIN EN ISO 8295. It is preferred if the coefficient of static friction of film/corrugated cardboard and film/board μ_{S} is ≧0.4, preferably ≧0.6, more preferably ≧0.8, and/or the coefficient of dynamic friction μ_{D} is ≧0.4, preferably ≧0.5, more preferably ≧0.7.

It is also possible that the film is of self-adhesive design on at least one of its sides. As a result of the fact that the film adheres to at least one of the adjoining layers, one of the two possible sliding zones is omitted, along which the upper layer can slide with respect to the lower layer. The risk of sliding is thus reduced further. This embodiment is particularly advantageous for banding.

If a goods stack is banded with an antislip film, with the result that the goods stack is covered on its surface at least partially with said antislip film, and if corresponding goods stacks are stacked onto a pallet, protection against sliding is produced at those contact faces of the stacks which are covered partially with antislip film. The ends of the film band can be welded or adhesively bonded, for example.

It is particularly preferred if in this case at least 5%, more preferably at least 10%, more preferably at least 15% of the upper side of the uppermost goods item of the goods stack and/or the underside of the lowermost goods item of the goods stack are covered by the film.

The band can have a width of from 50 to 350 mm, preferably of from 100 to 250 mm, more preferably of 150 mm. Furthermore, it can be self-adhesive on at least one of its sides. The assembly of the goods stack can be made more secure by a self-adhesive property of this type.

In relation to further possible properties of the film used for banding, reference is made to the above comments on the film strips.

The invention will then be explained in greater detail using the exemplary embodiments which are shown in the figures, in which:

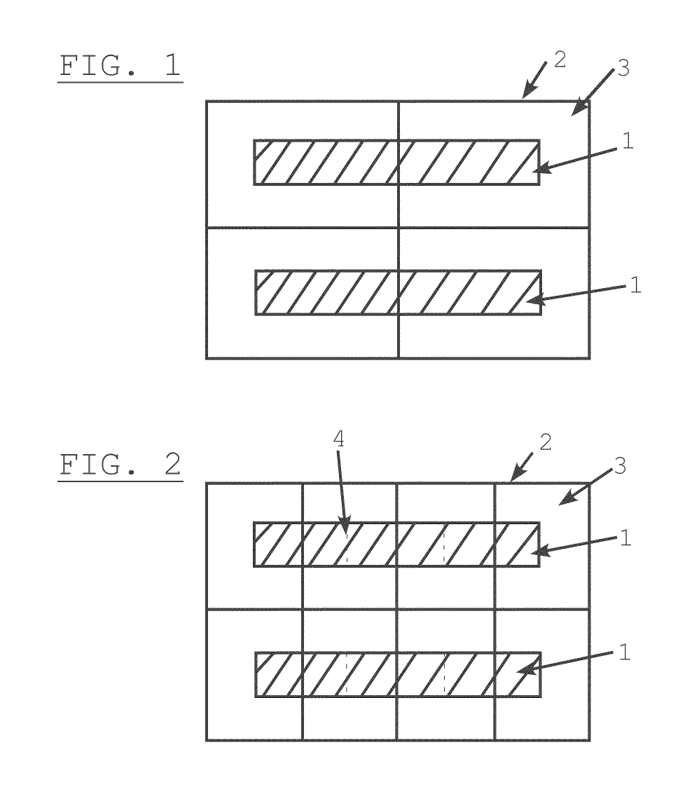

FIG. 1 shows a first exemplary embodiment of the use of a film for securing goods arranged in layers on a pallet against sliding;

FIGS. 2-7 show further exemplary embodiments;

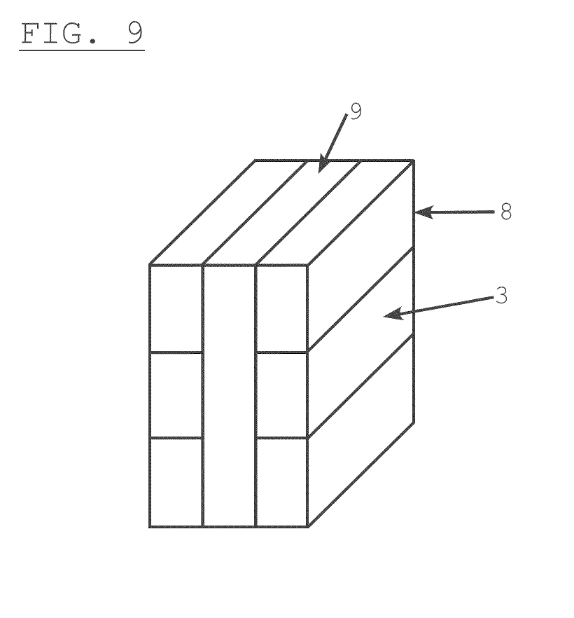

FIG. 8 shows a diagrammatic illustration of the tipping protection by way of the use according to the invention of a film for securing goods arranged in layers on a pallet; and

FIG. 9 shows an exemplary embodiment of the use of a film for banding goods to form a goods stack.

FIG. 1 shows a plan view of a layer 2 of goods 3, the goods 3 being arranged next to one another. The layer 2 is situated on a pallet 5 (not shown) and has the same dimensions as said pallet, namely 1200×800 mm.

Two film strips 1 are arranged on the layer 2. The two film strips 1 have a width of 150 mm and are cut to size to a length of 900 mm. The film strips 1 are arranged in such a way that, if another upper layer 2′ (not shown) with goods 3 of the same dimensions is placed onto the lower layer 2 shown, the film strips 1 are clamped in between the two layers 2, 2′, to be precise in such a way that in each case one goods item 3 of the upper layer 2′ is in contact with a goods item 3 of the lower layer 2 via a part of the film strips 1.

The surfaces of the film strips 1 are designed in such a way that they develop an antislip action. On account of this, the goods 3 of the upper layer 2′ are secured against sliding with respect to the lower layer 2.

In this exemplary embodiment, approximately 28% of the surface of the layer 2 are covered by the film strips 1.

The exemplary embodiment in FIG. 2 is similar to that from FIG. 1. Twice the number of goods 3 is provided in the lower layer 2. However, nothing has to be changed in the arrangement of the film strips with respect to the exemplary embodiment from FIG. 1, since, furthermore, when an upper layer 2′ with comparable goods 3 is positioned, a piece of the film strips 1 is clamped in between each goods item 3 of the lower layer 2 and that goods item 3 of the upper layer 2′ which lies above it. The desired antislip action is therefore achieved.

It is otherwise possible that layers 2, 2′ with goods 3 from the first exemplary embodiment alternate with layers 2, 2′ from the second exemplary embodiment on a pallet. Mixing of the goods 3 from the two exemplary embodiments mentioned within a single layer 2, 2′ is likewise possible. On account of the arrangement of the film strips 1, it is ensured that a piece of the film strips 1 is always clamped in between the goods 3 of the upper layer 2′ and the lower layer 2.

The film strips 1 in the second exemplary embodiment have perforations at a spacing of 300 mm in the direction of their length. On account of these perforations 4, it is possible to divide film strips 1 from a film reel, which film strips 1 have a length a multiple of which corresponds to the spacing between the perforations 4. In the example shown, the film strips 1 have a length of 900 mm.

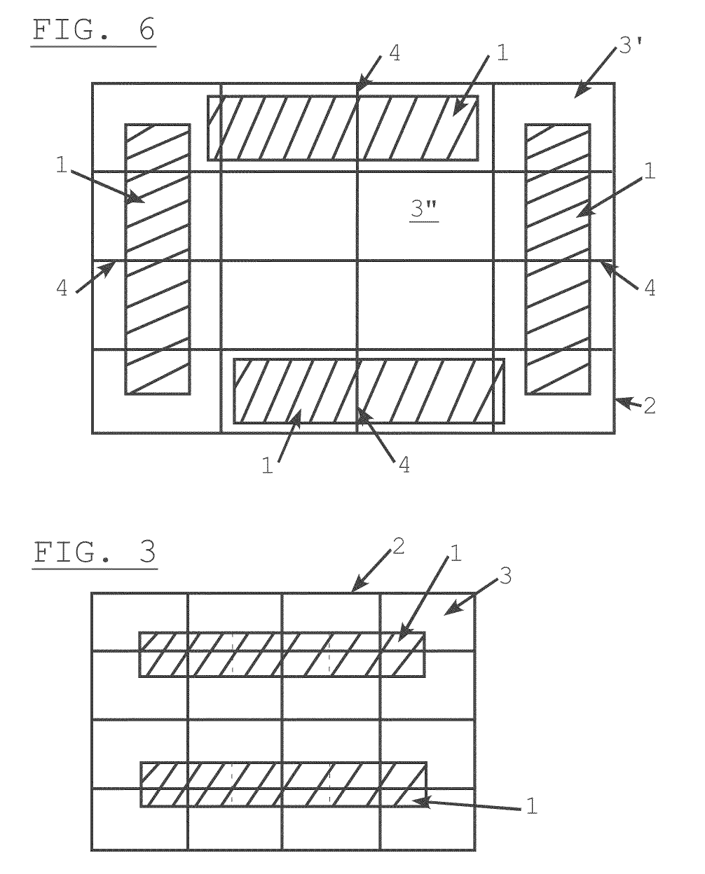

In the third exemplary embodiment in FIG. 3, in which the layer 2 is formed from sixteen goods 3, the film strips 1 can also be arranged as in the first two exemplary embodiments, without a functional loss occurring. Just like between the first and the second exemplary embodiment, it is also possible that a layer 2, 2′ according to the third exemplary embodiment alternates on a pallet with one or more of the exemplary embodiments mentioned first on a pallet. The coverage by the film strips 1 is also 28% of the surface area of the lower layer 2 here.

In order to increase the security further against individual layers 2, 2′ stacked above one another sliding, there can be provision for further film strips 1 to be introduced between the individual layers 2, 2′.

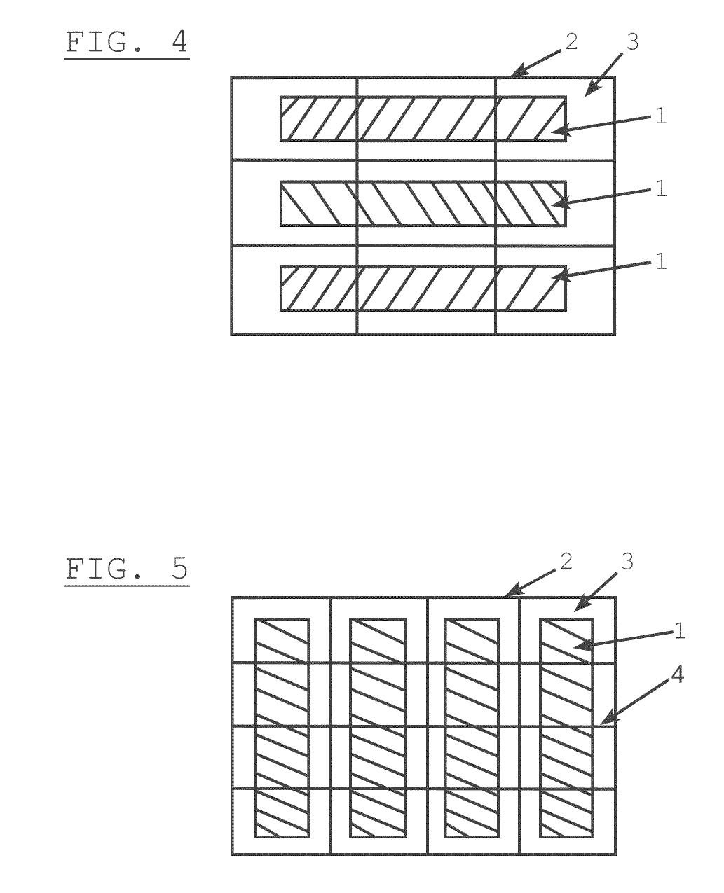

In FIG. 4, a third film strip 1 is also provided on the layer 2 from the second exemplary embodiment. As a result, the coverage by the film strips 1 is then 42% of the surface area of the layer 2, as a result of which overall greater adhesion is ensured between two layers 2, 2′ which lie above one another.

For the arrangement of goods 3 in a layer 2 like from the third exemplary embodiment, there is also the possibility of fitting with film strips 1 as shown in FIG. 5. In this exemplary embodiment, the film strips 1 have only the length of 600 mm which is easy to achieve on account of the perforations 4: In contrast to film strips 1 having a length of 900 mm, a 600 mm long film strip 1 comprises only two instead of three 300 mm long sections. In the exemplary embodiment, the coverage by the film strips 1 is 38% of the surface area of the layer 2.

In the previous exemplary embodiments, each goods item 3 of the layer 2 has been covered at least partially by a film strip 1. This is not mandatory, however. A further alternative is shown in the exemplary embodiment from FIG. 6.

In this exemplary embodiment, a distinction is made between outer goods 3′ and inner goods 3″. In this case, outer goods 3′ are distinguished by the fact that no further goods item 3 adjoins at least one side of the goods item 3′. The outer goods 3′ in this exemplary embodiment are therefore goods 3 which are arranged at the outer edge of the layer 2.

According to the invention, it is sufficient if the outer goods 3′ are covered by film strips 1; the inner goods 3″ are held by the outer goods 3′. The film strips 1 can be arranged as shown; they have a length of 600 mm because, in the exemplary embodiment shown, the upper layer 2′ which comes to rest on the lower layer 2 has substantially the same dimensions as the lower layer 2.

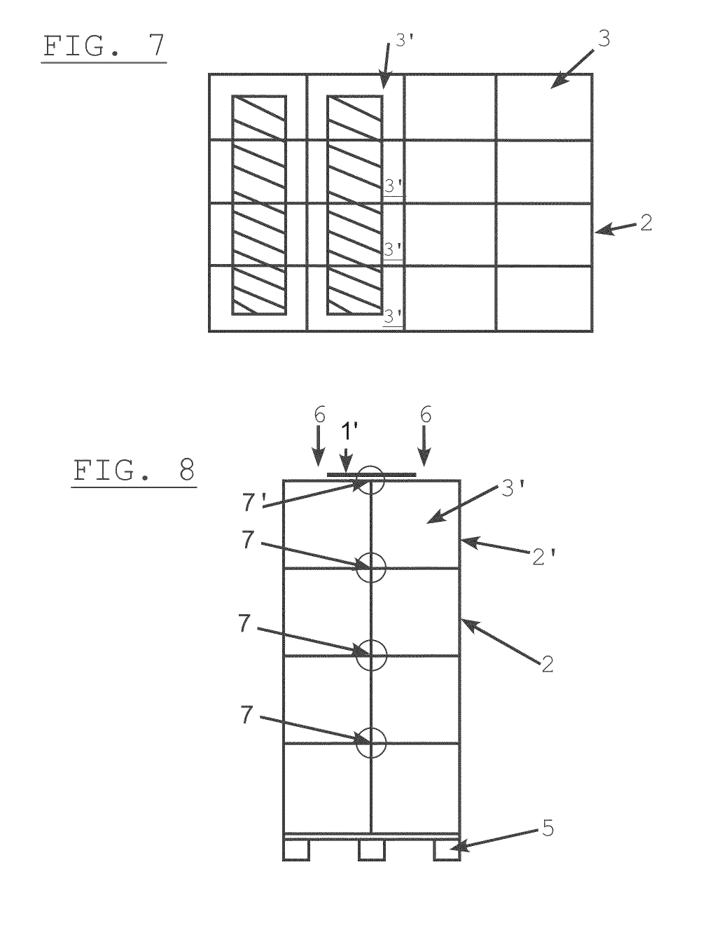

If the upper layer 2′ does not have the same dimensions as the lower layer 2, outer goods 3′ denote the goods which lie on the lower layer 2 at the outer edge of the supporting face of the goods 3 of the upper layer 2′. This circumstance is clarified by the exemplary embodiment in FIG. 7.

In this exemplary embodiment, only half of the upper layer 2′ is intended to rest on the lower layer 2. It can be, for example, eight goods 3 which are comparable with those in the lower layer 2. The goods of the upper layer 2′ then lie only on the goods 3 of half of the lower layer 2 which are all outer goods 3′. The film strips 1 are then arranged according to the above stipulations on the outer goods 3′. If the film strips 1 are self-adhesive on at least one of their sides, the film strip arrangement from FIG. 5 can be selected, even if the upper layer 2′ does not have the same dimensions as the lower layer 2. In this case, the bond between adjacent goods 3 is achieved not only by clamping the film strips 1 in between two layers 2, 2′, but rather additionally or exclusively by the self-adhesive properties of the film strips 1. Even goods 3, on which no further goods 3 lie (for example, goods 3 of the uppermost layer), can be secured on their upper side by partially self-adhesive film strips 1. This is true, in particular, with regard to the protection against tipping described below.

The use according to the invention of film strips 1 not only ensures protection against sliding of the individual layers 2, 2′ among one another, but rather also achieves protection against tipping. This is to be clarified using the sketch in FIG. 8.

FIG. 8 shows a pallet 5 loaded with goods 3 in side view; only the outer goods 3′ can be seen. The goods 3 are stacked in a plurality of layers 2, one goods item 3 of an upper layer 2′ always lying precisely on one goods item 3 of a lower layer 2. Here, “columns” 6 of stacked goods are produced.

According to the invention, film strips 1 (not shown) are provided between the individual layers 2, 2′, the film strips 1 being arranged in such a way that they span in each case two adjacent outer goods 3′. Since the film strips 1 are clamped in between the outer goods 3′ of the different layers 2, 2′, a connection is produced in the regions denoted by 7 between two adjacent columns 6, as a result of which the tipping of one of the two columns 6 shown is prevented. If the film strips 1 have self-adhesive properties on at least one of their sides, a film strip 1′ can also be provided on the upper side of the columns 6. The connection which is additionally present as a result of the two columns 6 in the region 7′ reduces the risk further of a column 6 tipping.

FIG. 9 shows how goods 3 can be banded to form goods columns 8. To this end, the goods 3 are stacked and have a band 9 wrapped around them in such a way that the goods 3 are combined to form an assembly.

The band 9 is manufactured from a material with antislip properties. Since it extends over both the upper side and the underside of the goods column 8, it is ensured that protection against sliding is always ensured between two goods columns 8 which are stacked on one another or between a goods column 8 with an individual goods item 3 which lies above or below it. Moreover, slipping with respect to an adjacent goods column 8 can also be prevented by the part of the band 9 on the sides of the goods column 8.

A triple layer plastic film has proven advantageous as material for the film strips 1 and/or the band 9. Here, the central layer serves as carrier layer for the two outer layers which in turn have corresponding coefficients of friction, in order to be suitable for the use according to the invention.

With a suitable film, the following measured values have been determined according to test standard DIN EN ISO 8295 in the test cases between film and corrugated cardboard and between film and board:

Coefficient of friction

| | Static μ_{S} | Dynamic μ_{D} |
|---|---|---|
| | (adhesion | (sliding |
| Material pairings | friction) | friction) |
| Film/corrugated | 0.88-0.9 | 0.73-0.8 |
| cardboard (in | | |
| direction of | | |
| corrugations) | | |
| Film/corrugated | 0.87-0.9 | 0.7-0.79 |
| cardboard | | |
| (transversely | | |
| with respect to | | |
| direction of | | |
| corrugations) | | |
| Film/folding box | 0.81-0.9 | 0.79-0.87 |
| board | | |

In each case a coefficient of static friction of ≧0.8 and a coefficient of dynamic friction of ≧0.7 have thus been achieved in the tests.

1. A method of securing goods (3) arranged in layers on a pallet (5) against sliding, comprising use of a film, the film being introduced between an upper layer (2′) and a lower layer (2) and having antislip properties, wherein the film is cut to size in film strips (1) the length of which is greater than their width, and the film strips (1) are arranged between the lower layer (2) and the upper layer (2′) in such a way that they cover a maximum of 60% of the contact area of the lower layer (2) with the upper layer (2′).

2. The method of claim 1, wherein the film strips (1) cover from 20 to 50%, preferably from 28 to 42%, of the contact area of the lower layer (2) with the upper layer (2′).

3. The method of claim 1, wherein the film strips (1) have a width of from 50 to 350 mm, preferably of from 100 to 250 mm, more preferably of approximately 150 mm.

4. The method of claim 1, wherein the film strips have a ratio of length to width of from 1.5:1 to 12:1, preferably of from 2:1 to 10:1, more preferably of from 3:1 to 8:1, more preferably of from 4:1 to 6:1.

5. The method of claim 1, wherein the film is wound up on a winding apparatus, the reel width of which corresponds to the width of the film strips (1) and in which a dividing element is provided which makes it possible to divide a film strip (1) of any desired length from the wound up film.

6. The method of claim 1, wherein the film is wound up on a reel the width of which corresponds to the width of the film strips (1), the film being perforated at regular intervals parallel to the axis of the reel.

7. The method of claim 6, wherein the spacing between two perforations (4) is from 100 to 500 mm, preferably from 200 to 400 mm, more preferably 300 mm.

8. The method of claim 1, wherein the film strips (1) have a length of at most 1200 mm, preferably of from 300 to 900 mm.

9. The method of claim 1, wherein the film has a thickness of from 10 to 100 μm, preferably of from 40 to 60 μm, more preferably of 50 μm and/or a weight per unit area of from 20 to 100 g/m2, preferably of from 30 to 80 g/m2, more preferably of from 40 to 60 g/m2.

10. The method of claim 1, wherein, during the determination of the coefficients of friction of film/corrugated cardboard and film/board according to DIN EN ISO 8295, has a static coefficient of friction μS of ≧0.4, preferably ≧0.6, more preferably ≧0.8 and/or a dynamic coefficient of friction μD of ≧0.4, preferably ≧0.5, more preferably ≧0.7.

11. The method of claim 1, wherein the film strips (1) are self-adhesive on at least one side.

12. The method of claim 1, wherein the film is manufactured from plastic, preferably a polyethylene, polypropylene or polyvinyl chloride plastic.

13. A method of securing goods (3) arranged in layers on a pallet (5) against sliding, comprising use of a film, wherein at least one part of the goods (3) are banded to form a goods stack (8), wherein the film for the band (9) is an antislip film.

14. The method of claim 12, wherein 5%, preferably at least 10%, more preferably at least 15% of the surface area of the upper side of the uppermost goods item (3) of the goods stack (8) and/or of the underside of the lowermost goods item (3) of the goods stack (8) are covered by the band (9).

15. The method of claim 13, wherein the antislip film is configured as defined in at least one of claims 3 and 9 to 12.
